(19) United States
(12) Patent Application Publication
(10) Pub. No.: US 2025/0135250 A1
(43) Pub. Date: May 1, 2025

(54) SPRAY SYSTEM FOR REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/923,905

(22) Filed: Oct. 23, 2024

Related U.S. Application Data
(60) Provisional application No. 63/593,786, filed on Oct. 27, 2023.

(51) Int. Cl. A62C 3/07; B60S 1/66; B65F 3/00

(52) U.S. Cl. CPC A62C 3/07; B65F 3/00; B60S 1/66

(57) ABSTRACT

A refuse vehicle includes a chassis a body assembly coupled to the chassis, the body assembly including a tailgate and a refuse compartment, the tailgate pivotably coupled with the refuse compartment and positioned at a rear of the refuse compartment, and a spray system coupled to the body assembly and configured to selectively activate to spray a fluid at a target, the target including at least one of the tailgate or the refuse compartment.

### CROSS-REFERENCE TO RELATED PATENT APPLICATIONS

This application claims the benefit of and priority to U.S. Provisional Application No. 63/593,786, filed on Oct. 27, 2023, the entire disclosure of which is hereby incorporated by reference herein.

### BACKGROUND

The present disclosure generally relates to the field of refuse vehicles. More specifically, the present disclosure relates to control systems for refuse vehicles.

### SUMMARY

One embodiment of the present disclosure relates to a refuse vehicle. The refuse vehicle includes a chassis a body assembly coupled to the chassis, the body assembly including a tailgate and a refuse compartment, the tailgate pivotably coupled with the refuse compartment and positioned at a rear of the refuse compartment, and a spray system coupled to the body assembly and configured to selectively activate to spray a fluid at a target, the target including at least one of the tailgate or the refuse compartment.

Another embodiment of the present disclosure relates to a spray system for a refuse vehicle. The spray system includes a fluid supply configured to store a fluid, a plurality of nozzles fluidly coupled with the fluid supply, the plurality of nozzles configured to be coupled to the refuse vehicle, the plurality of nozzles configured to direct a flow of the fluid at a target including at least one of a tailgate or a refuse compartment of the refuse vehicle, a valve fluidly coupled between the fluid supply and the plurality of nozzles and operable between an open position and a closed position, at least one sensor configured to monitor the refuse compartment and the tailgate, and a controller configured to actuate, based on data acquired by the at least one sensor, the valve between the open position and the closed position. In the open position, the valve permits the flow of the fluid from the fluid supply to the plurality of nozzles. In the closed position, the valve inhibits the flow of the fluid from the fluid supply to the plurality of nozzles.

Still another embodiment of the present disclosure relates to a refuse vehicle. The refuse vehicle includes a chassis, a body assembly coupled to the chassis, and a spray system. The body assembly includes a tailgate and a refuse compartment. The tailgate is pivotably coupled with the refuse compartment. The spray system is coupled to the body assembly and is configured to selectively activate to spray a fluid at refuse on the tailgate or in the refuse compartment. The spray system includes a fluid supply configured to store the fluid, a nozzle fluidly coupled with the fluid supply and coupled with the refuse vehicle, the nozzle configured to direct a flow of the fluid at the refuse, a valve fluidly coupled between the fluid supply and the nozzle and operable between an open position and a closed position, wherein, in the open position, the valve permits the flow of the fluid from the fluid supply to the nozzle, and wherein, in the closed position, the valve inhibits the flow of the fluid from the fluid supply to the nozzle, a sensor configured to monitor the tailgate and the refuse compartment, an actuator configured to selectively move the nozzle, and a control system. The control system is configured to determine, based on data acquired by the sensor, a location of the refuse on the tailgate or in the refuse compartment, and actuate the actuator to move the nozzle such that the flow of the fluid from the nozzle is directed at the location of the refuse.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a side view of a spray system of any of the refuse vehicles of FIGS. 1-3, according to an exemplary embodiment;

FIG. 7 is a rear perspective view of the spray system of any of the refuse vehicles of FIGS. 1-3, according to an exemplary embodiment; and

FIG. 8 is a block diagram if the spray system for any of the refuse vehicles of FIGS. 1-3, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, embodiments of a refuse vehicle are shown that include a spray system for cleaning refuse materials from various areas along and within the refuse vehicle. The spray system includes a fluid supply to store a fluid such as water and a plurality of nozzles fluidly coupled to the fluid supply via a supply line. The spray system may further include a pump in fluid communication with the fluid supply and the nozzles and configured to draw the fluid from the fluid supply. The nozzles are positioned along a rear of the refuse vehicle and oriented to spray the fluid supplied by the fluid supply at a target. The target may be refuse that has stuck to a refuse compartment or a tailgate of the refuse vehicle. The spray system further includes a valve configured to permit or prevent the flow of the fluid, the valve operatively coupled to a controller. The controller is configured to receive and transmit activation or deactivation signals to the spray system (e.g., the valve, the pump, etc.) to permit or substantially prevent the flow of the fluid through the nozzles and at the target. The spray system can, beneficially, remove refuse materials that can degrade sealing performance along an interface between a tailgate and the refuse compartment, which can reduce leakage of waste materials (e.g., sludge, liquid waste, etc.) from the refuse compartment during operation.

### Refuse Vehicle

### Front-Loading Configuration

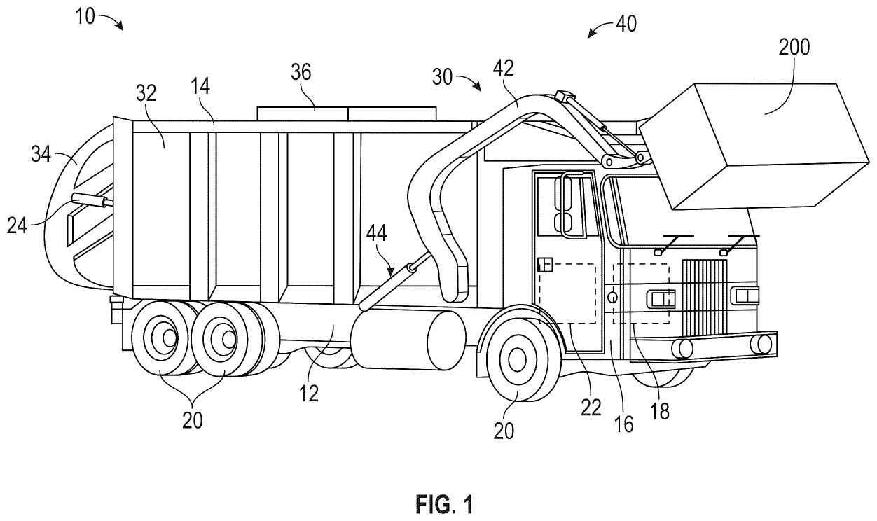

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as tractive elements 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotably coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotably coupled with the frame 12 such that the refuse compartment 30 can be driven to raise or lower while the tailgate 34 is open in order to dump contents of the refuse compartment 30 at a transfer station (e.g., a landfill). The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

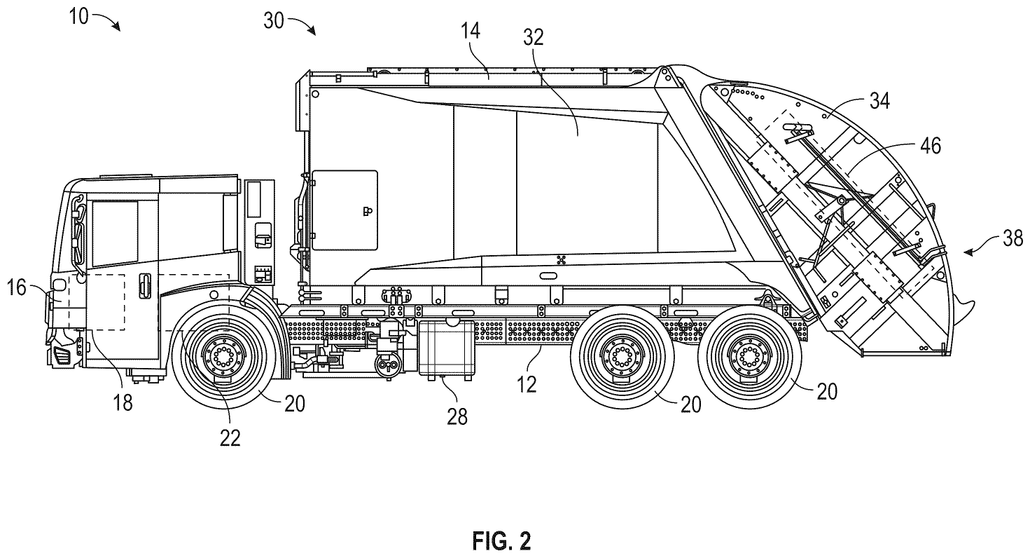

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

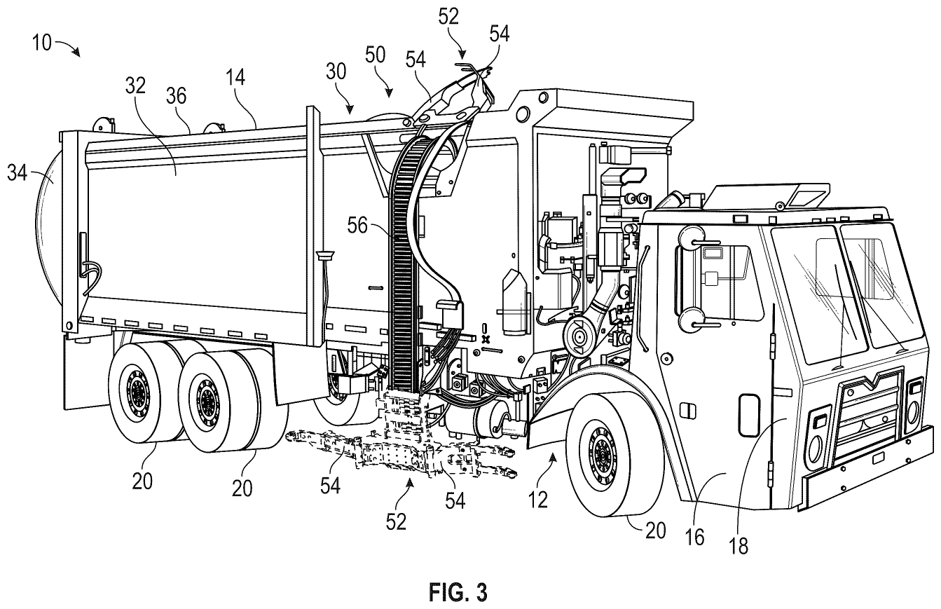

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly 52 may transition into the disengaged state, releasing the refuse container.

### Control System

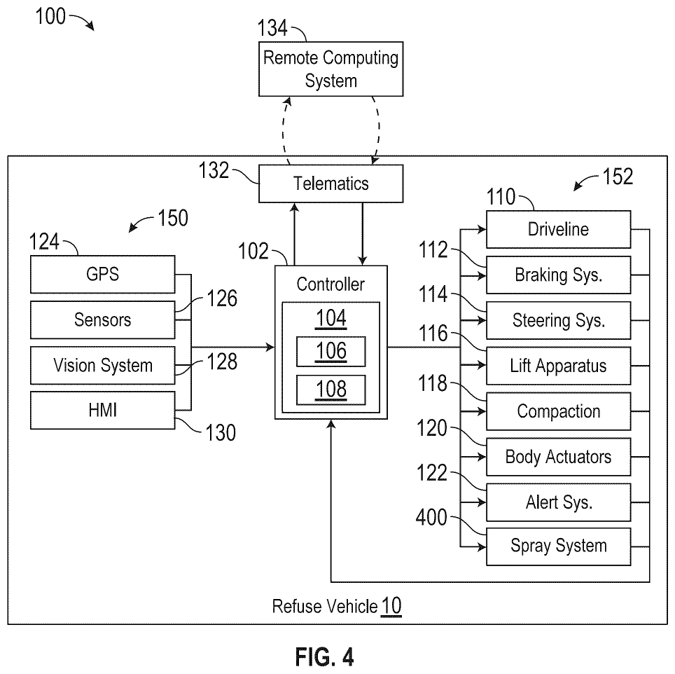

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”) 124, multiple sensors 126, a vision system 128 (e.g., an awareness system), and a Human Machine Interface (“HMI”) 130. The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller 102 may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

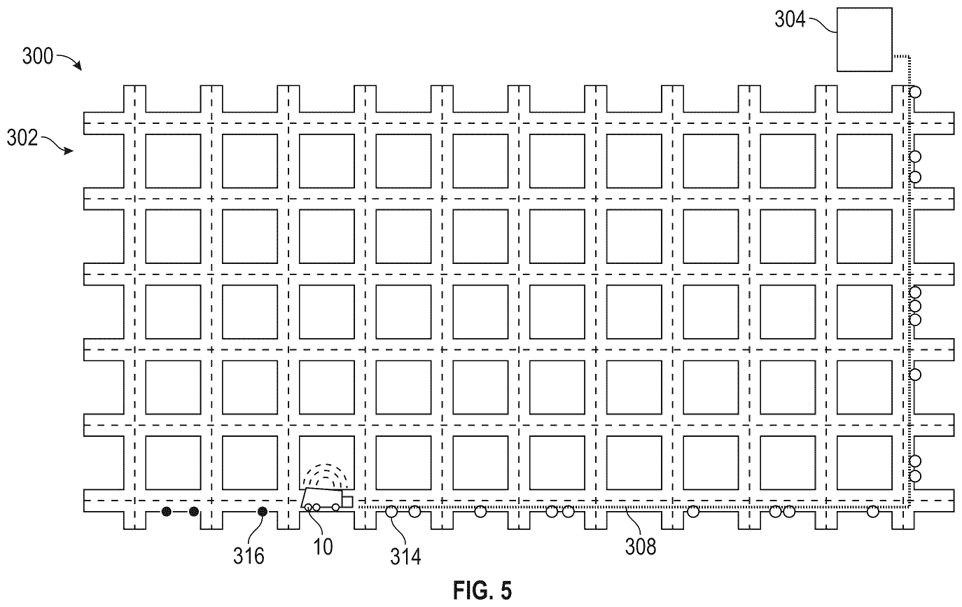

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location, a transfer station, etc.) where the refuse vehicle 10 may autonomously empty collected refuse, transport to a refueling location if necessary, and begin a new route.

### Spray System

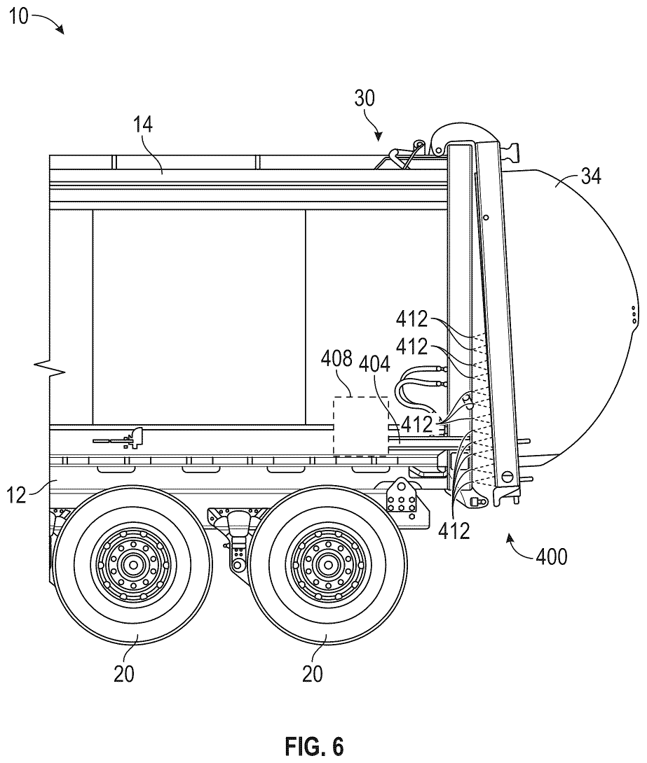

Referring to FIGS. 6-8, the refuse vehicle 10 includes a spray system (e.g., cleaning system, fire suppression system, nozzle assembly, etc.), shown as spray system 400, configured to supply a fluid to the tailgate 34 and the refuse compartment 30 to clean and remove refuse from the refuse vehicle 10. The spray system 400 supplies (e.g., sprays, directs, etc.) the fluid to the tailgate 34 and the refuse compartment 30 onto or around a target (e.g., refuse stuck to the tailgate 34 or the refuse compartment 30). The spray system 400 is operatively coupled to the controller 102 configured to selectively operate one or more valves (e.g., electrically-actuated valves, pneumatically activated valves, etc.) based on an activation signal to operate the spray system 400. A supply line 404 fluidly couples a fluid supply 408 to one or more nozzles 412 to spray the fluid into or around refuse stuck to the tailgate 34 or the refuse compartment 30 (e.g., the target). The spray system 400 can be used alone or in combination with other types of spray systems (e.g., sprinkler system, portable spray system, etc.). In some embodiments, multiple spray systems 400 are used in combination with one another to spray multiple areas of the refuse vehicle 10 (e.g., the body 14, the packer 46, the container 200, etc.).

In general, the refuse vehicle 10 is equipped with the compaction system 118 that is configured to eject refuse from the refuse compartment 30 of the refuse vehicle 10 during an ejection procedure. The ejection procedure extends the packer 46 from a retracted position to an extended position. The gradual increase in extension distance of the packer 46, accompanied with retracting back to the retracted position after reaching each extension distance, helps maintain refuse in front of the packer 46 and helps in preventing or inhibiting refuse from falling behind the packer 46. The ejection procedure facilitates removing the refuse from the refuse compartment 30 when the tailgate 34 is open and dumping the refuse at a landfill.

In some embodiments, the spray system 400 is configured to spray the tailgate 34 and the refuse compartment 30 to remove refuse that has stuck to the tailgate 34 and the refuse compartment 30 before, after, or during the ejection and dumping procedures. The fluid supplied by the spray system 400 to remove stuck refuse may be water. In some embodiments, the fluid includes a cleaning agent such as an alcohol-based disinfectant, bleach, a soap solution, a degreaser, and/or any other agent or combination of liquids to clean (e.g., disinfect, rinse, wash, degrease, etc.) the tailgate 34 and the refuse compartment 30. In some embodiments, the spray system 400 utilizes a multi-step spray method including spraying the tailgate 34 and the refuse compartment 30 with a first fluid such as water to remove stuck refuse, then spraying the tailgate 34 and the refuse compartment 30 with a second fluid such as a cleaning agent to clean the tailgate 34 and the refuse compartment 30.

The spray system 400 includes one or more containers (e.g., tanks, canisters, cans, cylinders, drums, etc.), shown as fluid supply 408, configured to contain a volume of the fluid. The fluid supply 408 is coupled to a valve, puncture device, or activator assembly, shown as valve 416. The valve 416 is configured to selectively fluidly couple an internal volume of the fluid supply 408 to a conduit (e.g., a hose, a pipe, a tube, etc.), shown as supply line 404. In some embodiments, the valve 416 is manually actuated by a user (e.g., by hand). In other embodiments, the valve 416 is actuated by a signal (e.g., an electrical signal, a flow of pressurized fluid, etc.). In such embodiments, the valve 416 is operatively coupled to the controller 102 and configured to receive a signal from the controller 102 associated with a command to actuate between an open and a closed position. In the open position, the valve 416 is configured to permit the flow of the fluid from the fluid supply 408 to the nozzles 412 (e.g., via the supply line 404). In other embodiments, the valve 416 is omitted, and the fluid supply 408 is directly coupled to the supply line 404. In some embodiments, the fluid supply 408 includes a check valve positioned along the supply line 404 and configured to (i) permit flow from the fluid supply 408 to the supply line 404 and (ii) limit (e.g., prevent) flow from the supply line 404 back to the fluid supply 408.

The supply line 404 fluidly couples the fluid supply 408 to one or more nozzles (e.g., spray bars, sprinklers, open nozzles, baffles), shown as nozzles 412. The supply line 404 may include one or more straight or bent sections of conduit and/or one or more fittings. One valve 416 may be associated with each nozzle 412 to selectively permit or prevent the flow of the fluid from the fluid supply 408 to each nozzle 412. In some embodiments, the fluid supply 408 is pressurized such that the fluid is stored in the internal volume of the fluid supply 408 at a first pressure and supplied to the supply line 404 and the nozzles 412 at a second pressure that is lower than the first pressure. In other embodiments, the fluid is supplied from the fluid supply 408 by way of another method such as a pump (e.g., pump 420, second pump 428), gravity flow, or some other pressure differential.

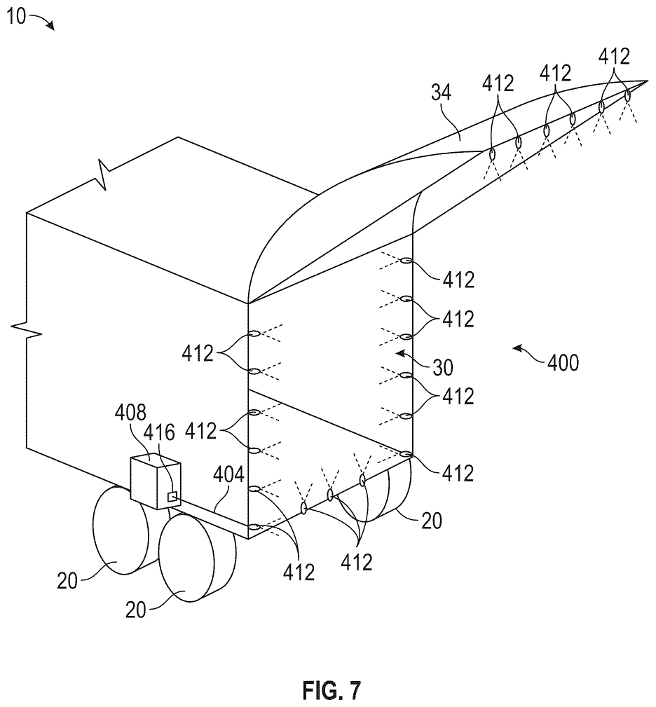

As shown in FIGS. 6 and 7, the spray system 400 includes a series of nozzles 412 fluidly coupled to one another. The nozzles 412 are coupled to the body 14 at the rear of the refuse compartment 30 and are positioned along the peripheral edges (e.g., side edges, bottom edge, top edge) of the refuse compartment 30 and the tailgate 34. In some embodiments, the nozzles 412 are coupled to the refuse compartment 30, the tailgate 34, and/or any other component of the refuse vehicle 10. The nozzles 412 are fluidly coupled to the fluid supply 408 via the supply line 404 and configured to supply (e.g., spray, deliver, direct, etc.) the fluid received from the fluid supply 408 to the refuse compartment 30 and the tailgate 34. In some embodiments, the nozzles 412 are oriented to direct the fluid at sections (e.g., targets) of the refuse compartment 30 and sections (e.g., targets) of the tailgate 34 that interface with one another when the tailgate 34 is in the closed position. By way of example, the nozzles 412 may spray the fluid at portions of the refuse compartment 30 and the tailgate 34 that form a seal when the tailgate 34 is in the closed position. By directing the fluid at these portions of the refuse compartment 30 and the tailgate 34, the nozzles 412 facilitate removing stuck refuse such that the tailgate 34 can create a substantially tight seal with the refuse compartment 30 when in the closed position.

In some embodiments, the nozzles 412 are selectively repositionable (e.g., movable, actuatable, etc.) to change where the flow of the fluid is directed. By way of example, the nozzles 412 may be manually repositionable relative to the body 14 to aim the flow of the fluid through the nozzles 412 at a section of the refuse compartment 30 or the tailgate 34 that is prone to have refuse stuck to it or any other desirable section or target. By way of another example, the nozzles 412 may be coupled with an actuator (e.g., a hydraulic cylinder, pneumatic cylinder, electric cylinder, motor, the body actuators 120 (e.g., tailgate actuators 24, lift or dumping actuators), etc.) operatively coupled to the controller 102 and configured to selectively reposition one or more of the nozzles 412 based on an activation signal (e.g., autonomously actuate based on sensor data, actuate in response to an input from an operator, etc.).

As shown in FIG. 4, the spray system 400 is in communication with (e.g., operatively coupled with) the controller 102. The memory 108 may contain one or more instructions that, when executed by the processor 106, cause the controller 102 to control the spray system 400 to perform the processes described herein. The controller 102 is configured to control operation of the valve 416 to actuate between an open position and a closed position. By way of example, the controller 102 may activate the valve 416 to supply the fluid from the fluid supply 408 to the refuse compartment 30 and the tailgate 34. As shown in FIG. 4, HMI 130 is operatively coupled to the controller 102 and configured to receive user inputs. The HMI 130 may be marked to indicate that a user should interact with the HMI 130 (e.g., push a button, pull a lever, etc.) in the event that stuck refuse has been detected (e.g., by the sensors 126 and/or the vision system 128) in the refuse compartment 30 or on the tailgate 34, before or after the ejection procedure. In response to an input from the user to the HMI 130, the controller 102 may activate the spray system 400 to direct fluid at refuse (e.g., stuck refuse) in the refuse compartment 30 or on the tailgate 34. In some embodiments, the operator may provide an input to the HMI 130 indicative of a target (e.g., stuck refuse, a specified portion of the refuse compartment 30 or the tailgate 34) for the nozzles 412 to direct the flow of fluid at. By way of example, the operator may specify, via the HMI 130, a target, and the controller 102 may control the spray system 400 to move the nozzles 412 to direct the flow of fluid at the specified target.

The sensors 126 and the vision system 128 may be configured to monitor the refuse compartment 30 and the tailgate 34 to detect a target including stuck refuse in the refuse compartment 30 or on the tailgate 34, before or after the ejection procedure. The sensors 126 may include object detection sensors, motion sensors, or any other environment sensor configured to detect stuck refuse in the refuse compartment 30 or on the tailgate 34. The vision system 128 may include cameras or any other image capturing component configured monitor the refuse compartment 30 and the tailgate 34. In some embodiments, the vision system 128 transmits real-time or previously recorded image data to the controller 102 to be displayed on the HMI 130 for a user to monitor. Collectively or individually, the sensors 126 and the vision system 128 operate to detect stuck refuse in the refuse compartment 30 or on the tailgate 34. Based on the data acquired by the sensors 126 and the vision system 128 the controller 102 may determine the presence or absence of refuse and/or a location of the refuse.

In response to a determination (e.g., based on the data acquired by the sensors 126 and the vision system 128) of the presence of refuse and the location thereof and/or in response to receiving a signal from the HMI 130 (e.g., based on an operator input thereto), the controller 102 is configured to transmit an activation signal to the valve 416. In some embodiments, the activation signal is an electrical signal. In other embodiments, the activation signal is or causes a flow of the fluid or a movement of a mechanical member (e.g., a cable, a lever, etc.). Upon receiving the activation signal from the controller 102, the valve 416 actuates to an open position to permit the flow of the fluid to the nozzles 412 which direct the flow of the fluid at the refuse compartment 30 and the tailgate 34 to remove stuck refuse. By way of example, the sensors 126 may include an optical sensor, a proximity sensor, or another type of sensor configured to detect the presence of refuse or leakage of refuse at sections of the refuse compartment 30 and sections of the tailgate 34 that interface with one another when the tailgate 34 is in the closed position, such that responsive to a detection of the refuse, the valve 416 actuates to the open position and the nozzles 412 direct the fluid at the refuse (e.g., at the sections of the refuse compartment 30 and sections of the tailgate 34 that interface with one another when the tailgate 34 is in the closed position). By way of another example, the sensors 126 may include a force sensor configured to monitor a closing force of the tailgate 34, the closing force being indicative of whether the tailgate 34 is in the closed position (e.g., a fully closed position). Responsive to a determination, based on the closing force, that the tailgate 34 is not closed (e.g., when it should be), the valve 416 actuates to the open position and the nozzles 412 direct the fluid at the sections of the refuse compartment 30 and sections of the tailgate 34 that interface with one another when the tailgate 34 is in the closed position. In such examples, the nozzles 412 may continue to direct the fluid at the refuse compartment 30 and the tailgate 34 (e.g., until the sensors 126 detect the absence of the refuse, until the closing force indicates that the tailgate 34 is in the closed position, etc.).

The controller 102 is configured to receive a signal (e.g., from the HMI 130 based on an operator input thereto to stop the flow of fluid, based on the data acquired by the sensors 126 and/or the vision system 128, etc.) to deactivate the spray system 400 to prevent the flow of the fluid to the nozzles 412. In response to receiving the signal, the controller 102 is configured to transmit a deactivation signal to the valve 416. The deactivation signal may be related to an indication commanding the valve 416 to move from an open position to a closed position. By way of example, a user may provide an input to the HMI 130, the input relating to a command to stop the spray system 400 from spraying the fluid. By way of another example, base on the data acquired by the sensors 126 or the vision system 128, the controller 102 may detect that the stuck refuse has been removed from the refuse compartment 30 or the tailgate 34 (e.g., by way of the nozzles 412 directing the fluid at the stuck refuse) and transmit a signal to the controller 102 to stop the spray system 400 from spraying the fluid. Upon receiving the signal, the controller 102 may transmit the deactivation signal to the valve 416 or any other component of the spray system 400 to prevent the flow of the fluid to the refuse compartment 30 and the tailgate 34. In some embodiments, the spray system 400 includes an emergency deactivation input (e.g., button, lever, handle, etc.) that, when activated (e.g., pressed, pulled, etc.) transmits the deactivation signal to the spray system 400 to move the valve 416 to a closed position or otherwise prevent the flow of the fluid.

In some embodiments, the nozzles 412 are operatively coupled to the controller 102. In such embodiments, the controller 102 is configured to transmit a signal commanding the nozzles 412 to move (e.g., via an actuator), thereby directing the fluid flowing through the nozzles 412 to be directed at a target (e.g., a desired section, a specified location, etc.) of the refuse compartment 30 or the tailgate 34. By way of example, in response to a user input to the HMI 130, the controller 102 may command one or more of the nozzles 412 to move to an orientation input by the user to the HMI 130. By way of another example, in response to receiving the detection signal from the sensors 126 or the vision system 128, the controller 102 is configured to command one or more of the nozzles 412 to move to an orientation such that the nozzles 412 direct the fluid at stuck refuse detected by the sensors 126 or the vision system 128.

In some embodiments, one or more nozzles 412 are coupled to an actuatable arm coupled to the body 14. The arm may be in communication with the controller 102 and configured to receive a command relating to the positioning of the arm relative to the body 14. During a spraying procedure, the controller 102 may command the arm to move the nozzles 412 to spray the refuse compartment 30 and the tailgate 34. By way of example, the arm may be controlled to direct the flow of the fluid through the nozzles 412 at sections of the tailgate 34 and the refuse compartment 30 that interface with one another when the tailgate 34 is in the closed position.

In some embodiments, one or more of the sensors 126 include tailgate sensors configured to detect a position of the tailgate 34 and provide an indication of whether the tailgate 34 is in an open position or a closed position. In some embodiments, the tailgate sensor includes a limit switch configured to detect the presence of the tailgate 34 in the closed position. In some embodiments, the tailgate sensor is in communication with the tailgate actuator 24 and is configured to detect a position of the tailgate 34 based on the tailgate actuator 24 (e.g., by detecting a position of a piston that extends from the tailgate actuator 24). In some embodiments, prior to transmitting the activation signal to the valve 416, the controller 102 initially verifies that the tailgate 34 is in the open position, via the tailgate sensor. If the tailgate sensor indicates that the tailgate 34 is in the closed position, an indication is provided to a user of the refuse vehicle 10 (e.g., a light, a sound, and/or a message displayed on a display) that instructs the user to open the tailgate 34. If the tailgate sensor indicates that the tailgate 34 is in the open position, the controller 102 instructs the spray system 400 to permit flow of the fluid to spray the stuck refuse (e.g., by actuating the valve 416 to the open position). In some embodiments, the controller 102 instructs the spray system 400 to permit flow of the fluid to spray the stuck refuse when the tailgate sensor detects the tailgate 34 has reached a predetermined position relative to the body 14. By way of example, after performing the ejection procedure, the tailgate 34 may automatically pivot from the open position to the closed position. Before reaching the closed position, the tailgate 34 may stop moving at the predetermined position. Once the tailgate 34 has stopped at the predetermined position, and the tailgate sensor detects the tailgate 34 at the predetermined position, the controller 102 instructs the spray system 400 to permit flow of the fluid to spray the refuse stuck to the refuse compartment 30 or the tailgate 34. The predetermined position may be any position before the tailgate 34 reaches the closed position (e.g., 6 inches from the closed position, 12 inches from the closed position, etc.). In some embodiments, the controller 102 instructs the spray system 400 to permit flow of the fluid to spray the refuse stuck to the refuse compartment 30 or the tailgate 34 during the ejection procedure.

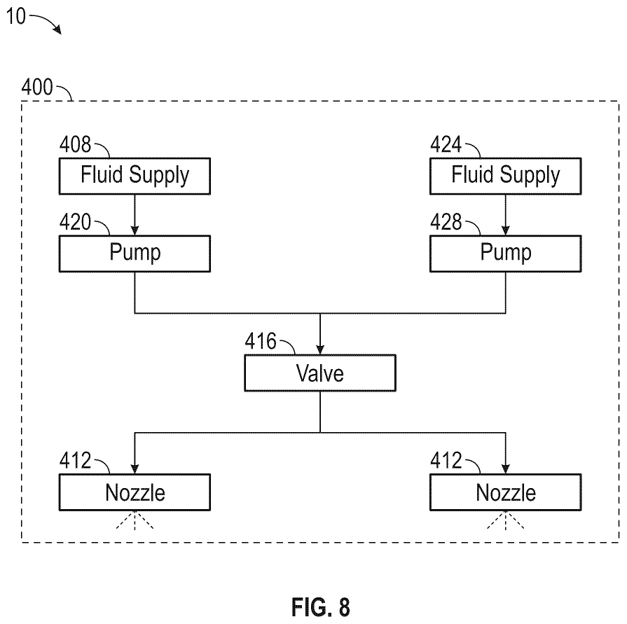

According to an exemplary embodiment shown in FIG. 8, the spray system 400 includes a pump 420 fluidly coupled to the fluid supply 408 and the nozzles 412 through one or more straight or bent sections of fluid conduit and/or other connectors (e.g., pipes, hoses, fittings, etc.). The pump 420 is configured to draw the fluid from the fluid supply 408 and provide the fluid to each of the nozzles 412 through the supply line 404. The controller 102 may be operatively coupled to the pump 420 to selectively control operation of, activate, deactivate, or otherwise provide commands to the pump 420. By way of example, the pump 420 may receive a signal from the controller 102 commanding the pump 420 to draw the fluid from the fluid supply 408 and provide the fluid to each of the nozzles 412 through the supply line 404 to be sprayed at a target (e.g., a portion of the refuse compartment 30, a portion of the tailgate 34, a component of the refuse vehicle 10, etc.).

According to an exemplary embodiment shown in FIG. 8, the spray system 400 may include two or more fluid supplies 408. Each fluid supply 408 may be configured to store fluids that are different from each other. By way of example, the fluid supply 408 may be a first fluid supply 408 that stores a first fluid such as water, a soap solution, etc. for cleaning, washing, or removing stuck refuse, and a second fluid supply 424 may store a second fluid that is different than the first fluid such as a fire suppressant. In such embodiments, the pump 420 selectively draws the first fluid from the first fluid supply 408, the second fluid from the second fluid supply 424, or a combination of the first fluid and the second fluid from the first fluid supply 408 and the second fluid supply 424, respectively. In other embodiments, the first fluid and the second fluid are the same. In some embodiments, the spray system 400 does not include the second fluid supply 424. Alternatively, the pump 420 is a first pump 420 configured to draw fluid from the first fluid supply 408, and the spray system 400 includes a second pump 428 configured to draw fluid from the second fluid supply 424. In some embodiments, the spray system 400 does not include the second pump 428.

In some embodiments, the spray system 400 is a fire suppression system configured to supply fire suppressant to one or more potentially flammable objects or areas in or around the refuse vehicle 10. In such embodiments, the fluid is a fire suppressant such as water, a clean agent, a powder agent, a noble gas, or any other inert gas or mixture of liquids and gasses. In the embodiment of a fire suppression system, the spray system 400 includes one or more sensors 126 that may be similar to the sensor(s) 126 as described in greater detail in U.S. Pat. No. 11,538,291, filed Apr. 16, 2021, the entire disclosure of which is incorporated by reference herein. The sensors 126 (e.g., hazard detection sensors, etc.) are configured to detect a presence of a thermal event, a fire, or an indication that a fire may be present, and, in response to such a detection, transmit a fire detection signal to the controller 102. In response to receiving the fire detection signal, the controller 102 is configured to send the activation signal to the valve 416 to permit the flow of the fire suppressant from the fluid supply 408 to the nozzles 412 which direct the fire suppressant onto or around the thermal event or the fire.

The spray system 400 of the present disclosure may be incorporated into other vehicles such as a mixing truck. In such embodiments, the spray system 400 is configured to facilitate cleaning or removing material build-up from one or more target portions or components of the mixing truck (e.g., a mixing drum, a mixing element, a hopper, a chute, etc.) to prevent the build-up of wet or dry concrete.

The spray system 400 of the present discloser provides various advantages over traditional methods used to clear stuck refuse from the refuse compartment 30, the tailgate 34, and the seal formed between the refuse compartment 30 and the tailgate 34 (e.g., the portions of the refuse compartment 30 and the tailgate 34 that interface with one another when the tailgate 34 is in the closed position). Traditionally, when refuse is stuck in the refuse compartment 30, on the tailgate 34, or between the seal formed between the refuse compartment 30 and the tailgate 34, an operator is required to manually clear the stuck refuse. Exiting the refuse vehicle 10 before, during, or after the ejection procedure (e.g., at a landfill, at a transfer station, etc.) may be dangerous for the operator, who may be struck by other vehicles driving near or around the refuse vehicle 10 performing the ejection procedure. Therefore, automatically removing stuck refuse from the refuse compartment 30 and the tailgate 34 (e.g., without the need of the operator to exit the cab 16), by way of the operations described herein performed by the spray system 400, allows the operator to stay in the cab 16 while the spray system 400 cleans the refuse compartment 30 and the tailgate 34. Further, when refuse is stuck between the seal formed between the refuse compartment 30 and the tailgate 34, refuse (e.g., debris, hazardous waste, fluids, garbage, etc.) stored inside the refuse compartment 30 may escape while the refuse vehicle 10 is stopped at a stop 316, while in transit between stops 316, and/or while in transit to or from the landfill 304. The spray system 400 facilitates clearing the refuse from the seal before the tailgate 34 has reached the closed position, thereby preventing refuse from escaping the refuse compartment 30.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body assembly coupled to the chassis, the body assembly including a tailgate and a refuse compartment, the tailgate pivotably coupled with the refuse compartment and positioned at a rear of the refuse compartment; and
a spray system coupled to the body assembly and configured to selectively activate to spray a fluid at a target, the target including at least one of the tailgate or the refuse compartment.

2. The refuse vehicle of claim 1, wherein the spray system includes:
a fluid supply configured to store the fluid;
a nozzle fluidly coupled with the fluid supply and coupled to the body assembly and positioned at the rear of the refuse compartment, the nozzle configured to direct a flow of the fluid at the target; and
a valve fluidly coupled between the fluid supply and the nozzle and operable between an open position and a closed position,
wherein, in the open position, the valve permits the flow of the fluid from the fluid supply to the nozzle, and
wherein, in the closed position, the valve inhibits the flow of the fluid from the fluid supply to the nozzle.

3. The refuse vehicle of claim 2, wherein the spray system includes a plurality of nozzles fluidly coupled to the fluid supply and the valve, the plurality of nozzles positioned along at least one of a peripheral edge of the refuse compartment or the tailgate, and wherein the plurality of nozzles are oriented to spray the fluid at the target when the valve is in the open position.

4. The refuse vehicle of claim 2, wherein the nozzle is configured to direct the fluid at portions of the tailgate and the refuse compartment forming a seal when the tailgate is in a closed position.

5. The refuse vehicle of claim 2, wherein the spray system includes a controller, wherein the valve is configured to actuate to (i) the open position in response to receiving an activation signal from the controller and (ii) the closed position in response to receiving a deactivation signal from the controller.

6. The refuse vehicle of claim 5, wherein the spray system includes a tailgate sensor configured to detect a position of the tailgate and provide an indication to the controller of whether the tailgate is in an open position or a closed position, wherein the controller is configured to actuate the valve to the open position in response to receiving the indication of the tailgate being in the open position.

7. The refuse vehicle of claim 5, wherein the spray system includes an object detection sensor configured to monitor the tailgate and the refuse compartment, and wherein, the controller is configured to determine, based on data acquired by the object detection sensor, whether an object is stuck to the tailgate or the refuse compartment, and activate the spray system to spray the fluid at the object.

8. The refuse vehicle of claim 5, wherein the spray system includes a hazard detection sensor configured to monitor the refuse compartment for a presence of a thermal event.

9. The refuse vehicle of claim 8, wherein the controller is configured to:
receive a signal from the hazard detection sensor relating to the presence of the thermal event;
determine, based on the signal, if the thermal event is present; and
activate the spray system in response to a determination that the thermal event is present, wherein the fluid includes a fire suppressant.

10. The refuse vehicle of claim 2, wherein the spray system includes an actuator configured to selectively move the nozzle to direct the flow of the fluid at the target.

11. The refuse vehicle of claim 2, wherein the spray system includes a pump configured to draw the fluid from the fluid supply and provide the fluid to the nozzle.

12. The refuse vehicle of claim 2, wherein the fluid supply is a first fluid supply configured to store a first fluid of a first type, and wherein the spray system includes a second fluid supply configured to store a second fluid of a second type different than the first type.

13. The refuse vehicle of claim 1, wherein the target includes refuse stuck to the tailgate or the refuse container.

14. The refuse vehicle of claim 1, wherein the fluid includes at least one of water, a cleaning agent, or a fire suppressant.

15. A spray system for a refuse vehicle, the spray system comprising:
a fluid supply configured to store a fluid;
a plurality of nozzles fluidly coupled with the fluid supply, the plurality of nozzles configured to be coupled to the refuse vehicle, the plurality of nozzles configured to direct a flow of the fluid at a target including at least one of a tailgate or a refuse compartment of the refuse vehicle;
a valve fluidly coupled between the fluid supply and the plurality of nozzles and operable between an open position and a closed position;
at least one sensor configured to monitor the refuse compartment and the tailgate; and
a controller configured to actuate, based on data acquired by the at least one sensor, the valve between the open position and the closed position,
wherein, in the open position, the valve permits the flow of the fluid from the fluid supply to the plurality of nozzles, and wherein, in the closed position, the valve inhibits the flow of the fluid from the fluid supply to the plurality of nozzles.

16. The spray system of claim 15, wherein a first subset of nozzles of the plurality of nozzles is coupled to a peripheral edge of the refuse compartment and a second subset of nozzles of the plurality of nozzles is coupled to the tailgate.

17. The spray system of claim 15, wherein the target includes a section of the refuse compartment and a section of the tailgate that interface with one another when the tailgate is in a closed position.

18. The spray system of claim 15, wherein the target includes refuse stuck to the tailgate or the refuse container, and wherein the controller is configured to determine a location of the target based on data acquired by the at least one sensor.

19. The spray system of claim 15, further comprising an actuator configured to selectively move the plurality of nozzles, and wherein the controller is configured to actuate the actuator to direct the flow of the fluid at the target based on data acquired by the at least one sensor.

20. A refuse vehicle comprising:
a chassis;
a body assembly coupled to the chassis, the body assembly including a tailgate and a refuse compartment, the tailgate pivotably coupled with the refuse compartment; and
a spray system coupled to the body assembly and configured to selectively activate to spray a fluid at refuse on the tailgate or in the refuse compartment, the spray system including:
a fluid supply configured to store the fluid;
a nozzle fluidly coupled with the fluid supply and coupled with the refuse vehicle, the nozzle configured to direct a flow of the fluid at the refuse;
a valve fluidly coupled between the fluid supply and the nozzle and operable between an open position and a closed position, wherein, in the open position, the valve permits the flow of the fluid from the fluid supply to the nozzle, and wherein, in the closed position, the valve inhibits the flow of the fluid from the fluid supply to the nozzle;
a sensor configured to monitor the tailgate and the refuse compartment;
an actuator configured to selectively move the nozzle; and
a control system configured to:
determine, based on data acquired by the sensor, a location of the refuse on the tailgate or in the refuse compartment; and
actuate the actuator to move the nozzle such that the flow of the fluid from the nozzle is directed at the location of the refuse.
